(19) United States
(12) Patent Application Publication
(10) Pub. No.: US 2006/0095590 A1
(43) Pub. Date: May 4, 2006

(54) Exchange of encoded data packets

(75) Inventor: Keith Miller, Plano, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/983,173

(22) Filed: Nov. 4, 2004

(51) Int. Cl. G06F 15/16

(52) U.S. Cl. 709/246

(57) ABSTRACT

A method enables an exchange of encoded data packets between a first electronic device and a second electronic device, wherein the first electronic device supports a first type of coding. In case the second electronic device supports the first type of coding, a header reduction component is used to perform a header reduction and extension, respectively, on data packets encoded with the first type of coding. In case the second electronic device supports a second type of coding, the header reduction component is modified to convert data packets encoded with the first type of coding into data packets encoded with the second type of coding, and to convert data packets encoded with the second type of coding into data packets encoded with the first type of coding.

### FIELD OF THE INVENTION

The invention relates to a method for enabling an exchange of encoded data packets between a first electronic device and a second electronic device, wherein the first electronic device supports a first type of coding. The invention relates equally to corresponding header reduction component, to a corresponding electronic device, to a corresponding network element, to a corresponding communication system and to a corresponding software program product.

### BACKGROUND OF THE INVENTION

An example for an exchange of encoded data packets between electronic devices is voice-over-IP (VoIP), where speech data packets are transmitted between at least two terminals via an Internet Protocol (IP) network. The speech data, which is to be transmitted, can be encoded into data packets based on various types of coding. If the terminals are mobile terminals, which are connected to the IP network via a respective mobile communication network, for instance, possible encoding schemes comprise the Adaptive Multi-Rate Wideband (AMR-WB) coding scheme and the Variable Multi-Rate Wideband (VMR-WB) coding scheme.

The AMR-WB speech codec was developed by the 3^{rd} Generation Partnership Project (3GPP) for use in the Global System for Mobile communications (GSM) and in 3G cellular systems. See the Website www.3gpp.org for background informaton on CDMA. The multi-rate encoding capability of this codec allows preserving a high speech quality under various transmission conditions. The document IETF RFC 3267, June 2002, which is incorporated by reference herein, deals for example with the “Real-Time Transport Protocol (RTP) Payload Format and File Storage Format for the Adaptive Multi-Rate (AMR) and Adaptive Multi-Rate Wideband (AMR-WB) Audio Codecs”.

The VMR-WB speech codec was developed by the 3^{rd} Generation Partnership Project 2 (3GPP2) for encoding and decoding wideband and narrowband speech content in multimedia services in 3G Code Division Multiple Access (CDMA) cellular systems. See the Website www.3gpp2.org for background information on WCDMA. The document IETF Draft draft-ahmadi-avt-rtp-vmr-wb-02.txt, May 2004, which is incorporated by reference herein, deals for example with the “Real-Time Transport Protocol (RTP) Payload and File Storage Format for the Variable Multi-Rate Wideband (VMR-WB) Speech Codec”.

While the VMR-WB algorithm is based on the AMR-WB algorithm, it is optimized to operate efficiently in the 3GPP2 cdma2000® system by using a source-controlled variable-bit-rate paradigm and by using a half-rate, a quarter-rate and an eighth rate encoding scheme in addition to a full-rate coding scheme. These modifications result in different frame formats of VMR-WB encoded data packets compared to AMR-WB encoded data packets.

If two terminals between which encoded speech data packets are to be transmitted support different types of coding, it has to be ensured that a conversion is enabled between differently encoded data packets.

The document 3GPPS2 C.S0052-0 V1.0: “Source-Controlled Variable-Rate Multimode Wideband Speech Codec (VMR-WB): Service Option 62 for Spread Spectrum Systems”, June 2004, which is incorporated by reference herein, deals with a conversion between AMR-WB data packets and VMR-WB data packets. It is indicated that for a bi-directional interoperability between VMR-WB and AMR-WB codecs, interworking functions residing in an intermediate gateway are required.

It shall be understood that a similar data packet conversion may be required for the interoperability between other types of speech coding and equally for other types of data than speech data.

### SUMMARY OF THE INVENTION

It is an object of the invention to enable an improved data exchange between two electronic devices, when the devices do not support the same type of coding.

A method for enabling an exchange of encoded data packets between a first electronic device and a second electronic device is proposed, wherein the first electronic device supports a first type of coding. In case the second electronic device supports the first type of coding, the method comprises using a header reduction component to perform a header reduction and extension, respectively, on data packets encoded with the first type of coding, which are exchanged between the first electronic device and the second electronic device. In case the second electronic device supports a second type of coding, the method comprises modifying the header reduction component to convert data packets encoded with the second type of coding, originating from the second electronic device and addressed to the first electronic device into data packets encoded with the first type of coding, and to convert data packets encoded with the first type of coding, originating from the first electronic device and addressed to the second electronic device into data packets encoded with the second type of coding.

Moreover, a header reduction component is proposed, which enables an exchange of encoded data packets between a first electronic device and a second electronic device, wherein the first electronic device supports a first type of coding. The proposed header reduction component is adapted to perform a header reduction and extension, respectively, on data packets encoded with the first type of coding, which are exchanged between the first electronic device and the second electronic device, in case the second electronic device supports the first type of coding. The header reduction component is adapted to convert data packets encoded with the second type of coding, originating from the second electronic device and addressed to the first electronic device into data packets encoded with the first type of coding, and to convert data packets encoded with the first type of coding, originating from the first electronic device and addressed to the second electronic device into data packets encoded with the second type of coding, in case the second electronic device supports a second type of coding.

Moreover, an electronic device which comprises such a header reduction component and a codec supporting a first type of coding is proposed.

Moreover, a network element for a communication network which comprises such a header reduction component is proposed.

Moreover, a communication system enabling an exchange of encoded data packets between a first electronic device and a second electronic device is proposed. The proposed system comprises the proposed header reduction component, a communication network and the first electronic device, wherein this first electronic device supports a first type of coding and is adapted to access the communication network.

Finally, a software program product is proposed, in which a software code for enabling an exchange of encoded data packets between a first electronic device and a second electronic device is stored, wherein the first electronic device supports a first type of coding. When running in a processing component, the software code realizes the following steps: In case the second electronic device supports the first type of coding, the software code performs a header reduction and extension, respectively, on data packets encoded with the first type of coding, which are exchanged between the first electronic device and the second electronic device. In case the second electronic device supports a second type of coding, the software code converts data packets encoded with the second type of coding, originating from the second electronic device and addressed to the first electronic device into data packets encoded with the first type of coding, and converts data packets encoded with the first type of coding, originating from the first electronic device and addressed to the second electronic device into data packets encoded with the second type of coding.

The invention proceeds from the consideration that a conversion of encoded data packets can be combined advantageously with a header reduction and expansion, which is provided for encoded data packets. It is therefore proposed that a conventional header reduction and expansion is performed whenever the type of coding supported by two electronic devices involved in a data exchange is the same, and that this conventional header reduction and expansion is modified whenever the type of coding supported by two electronic devices involved in a data exchange is not the same. The modification ensures that the type of coding of encoded data packets, which are exchanged between the electronic devices, is converted.

It is an advantage of the invention that it combines a coding related interoperability with header reduction functionality. As a result, the necessity of an intermediate gateway for performing the data packet conversion may be avoided.

In one embodiment of the invention, the header reduction comprises header removal or header compression. Correspondingly, the header extension comprises in this embodiment header adding or header decompression, respectively.

The header reduction component can be located at any suitable location on the transmission path of the encoded data packets.

In one embodiment of the invention, the header reduction component is, for example, a part of the first electronic device. In this case, the header reduction comprises a header reduction of data packets which are encoded with the first type of coding by the first electronic device and which are addressed to the second electronic device. The header extension comprises correspondingly a header extension of data packets which are encoded with the first type of coding, which originate from the second electronic device and which are received by the first electronic device.

In another embodiment of the invention, the header reduction component is, for example, a part of a network, which is accessed by the first electronic device for exchanging the encoded data packets. In this case, the header reduction comprises a header reduction of data packets which are encoded with the second type of coding, which originate from the second electronic device and which are addressed to the first electronic device. The header extension comprises correspondingly a header extension of data packets which are encoded with the first type of coding, which originate from the first electronic device and which are addressed to the second electronic device.

The encoded data packets may comprise any type of data, and the supported types of coding may be adapted to the type of data. The conversion may also be enabled for more than two types of coding. The only precondition is that a conversion between data packets encoded with different types of coding can be calculated. An encoded data packet may consist in a frame including frame header and payload or it may consist only in the payload, for instance an RTP/User Datagram Protocol (UDP)/IP payload. The header reduction and expansion may be provided for frame headers and/or for headers included in the payload of a data packet.

In case the encoded data packets comprise speech data, for example, the first type of coding may be a VMR-WB speech coding and the second type of coding an AMR-WB speech coding.

A conversion of an AMR-WB encoded data packet to a VMR-WB encoded data packet, and vice versa, advantageously take account of various data rates which are enabled for a VMR-WB coding and of the possible lengths of AMR-WB encoded data packets.

In one embodiment of the invention, the header reduction and the header extension performed by the header reduction component is based on 3GPP2 service options SO60 or SO61, while the conversion which is performed by the modified header reduction component is based on the above mentioned 3GPP2 service option SO62.

The service options SO60 and SO61 are described in the document 3GPP2 C.S0047-0 V1.0: “Link-Layer Assisted Service Options for Voice-Over-IP: Header Removal (SO60) and Robust Header Compression (SO61)”, April 2003, which is incorporated by reference herein.

The existing service option SO60 and service option SO61 can be modified to this end such that they provide a VMR-WB and AMR-WB interoperability in accordance with service option SP62 whenever required. As a result, a VMR-WB device may interoperate with an AMR-WB device without involving an additional gateway and use the air-interface in the most efficient manner.

In this embodiment, the invention combines the VMR-WB and AMR-WB interoperability functionality of service option SO62 optimally with the existing header-removal and header compression service options SO60 and SO61, respectively, for a cdma2000® spread spectrum system. It also provides interoperability for VoIP calls without an intervening gateway.

In another embodiment of the invention, the header reduction and the header extension performed by the header reduction component is a Robust Header Compression (ROHC) defined for GSM and for a 3G Wideband Code Division Multiple Access (WCDMA) system. ROHC is described for example in the document IETF RFC 3095: “Robust Header Compression (ROHC): Framework and four profiles: RTP, UDP, ESP, and uncompressed”, July 2001, which is incorporated by reference herein. This document specifies a header compression scheme for RTP/UDP/IP, UDP/IP, and Encapsulating Security Payload (ESP)/IP headers.

The functions of the header reduction component may be realized in particular, though not necessarily, by a software algorithm which is adapted to realize the header reduction, the header extension and the conversion in accordance with the invention.

In order to enable a determination which type of coding is supported by the second electronic device, the electronic devices may exchange signaling messages, at least one of which indicates a type of coding which is supported by the other electronic device.

A signaling message comprising an indication of the type of coding supported by the second electronic device may be evaluated at the first electronic device or at a network element of a network, which is accessed by the first electronic device for determining which type of coding is supported by the second electronic device. The information obtained in the evaluation may be used for deciding whether the header reduction component has to be modified to perform a data packet conversion.

If the involved electronic devices are Session Initiation Protocol (SIP) enabled devices, the signaling may be, for example, a SIP/Session Description Protocol (SDP) signaling. A SIP offer-answer model and some aspects of interoperability are described for instance in the above cited document draft-ahmadi-avt-rtp-vmr-wb-02.txt.

Additional information supporting a data packet conversion may be available from a network which the first electronic device accesses.

The header reduction component according to the invention may comprise or co-operate with an evaluation component. This evaluation component is adapted to evaluate signaling messages which are exchanged between the first electronic device and the second electronic device for determining the type of coding supported by the second electronic device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram of a first system according to an embodiment of the invention;

FIG. 2 is a schematic diagram of a second system according to an embodiment of the invention;

FIG. 3 is a flow chart illustrating a signaling based decision on using a normal or a modified service option SO60/61 in the system of FIG. 2;

FIG. 4 is a flow chart illustrating the use of a modified service option SO60/61 on a forward link in the system of FIG. 2; and

FIG. 5 is a flow chart illustrating the use of a modified service option SO60/61 on a reverse link in the system of FIG. 2.

### DETAILED DESCRIPTION OF THE INVENTION

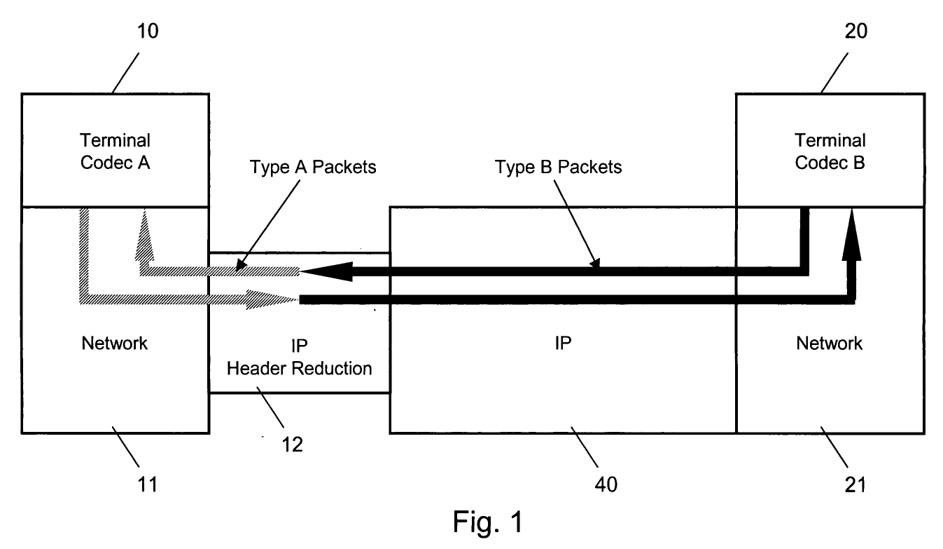

FIG. 1 is a schematic diagram of a system according to an embodiment of the invention, which enables interoperability between devices using a first type of codec and a second type of codec.

The system comprises a first terminal 10 using a first type of codec A. The first terminal 10 is only able to send and receive data packets of a type A. More specifically, the first terminal 10 is able to encode data which is to be transmitted using the first type of codec A, resulting in encoded data packets of type A, and to decode received encoded data packets of type A using the first type of codec A. This terminal 10 accesses a first mobile communication network 11 via a radio interface. The first mobile communication network 11 only supports a transfer of encoded data packets of type A.

The system further comprises a second terminal 20 using a second type of codec B. The second terminal 20 is only able to send and receive data packets of type B. More specifically, the second terminal 20 is able to encode data which is to be transmitted using the second type of codec B, resulting in encoded data packets of type B, and to decode received data packets of type B using the first type of codec B. This terminal 20 accesses a second mobile communication network 21 via a radio interface. The second mobile communication network 21 only supports a transfer of encoded data packets of type B.

The first mobile communication network 11 comprises an IP header reduction component 12. The first mobile communication network 11 is connected via the IP header reduction component 12 and an IP network 40 to the second mobile communication network 21.

The IP header reduction component 12 provides a header reduction function, for instance by means of a software algorithm. The header reduction function can be either a header removal function or a header compression function.

A header removal function is able to add a header to data packets provided by the first terminal 10 to the first mobile communication network 11 before the data packets are forwarded to the IP network 40. A header removal function is further able to remove a header of data packets, which are received via the IP network 40 before they are forwarded to the first terminal 10. A header removal function can be provided for instance in case the first terminal 10 is adapted to process only the payload of a data packet.

A header compression function is able to decompress the header of data packets provided by the first terminal 10 to the first mobile communication network 11 before they are forwarded to the IP network 40. A header compression function is further able to compress the header of data packets, which are received via the IP network 40 before they are forwarded to the first terminal 10. A header compression can be provided for instance in order to minimize the amount of data which is exchanged via the radio interface between the first terminal 10 and the first mobile communication network 11.

The header reduction function is moreover realized such that it can be modified to convert type A data packets received from the first terminal 10 into type B data packets and to convert type B data packets received from the second terminal 20 into type A data packets.

Further terminals can be connected via a respective mobile communication network to the IP network 40.

When the first terminal 10 wants to establish a connection to another terminal, it transmits an SIP/SDP invite message to this terminal via the first network 11, the IP network 40 and the mobile communication network which the other terminal accesses. The invite message includes an offer for both types of codecs A and B.

If the other terminal desires to participate in the connection, it transmits thereupon an SIP/SDP accept message to the first terminal 10 via the mobile communication network it accesses, via the IP network 40 and via the first mobile communication network 11. The accept message includes an indication which type of coding is supported by the other terminal.

If the other terminal is a terminal using a first type of codec A as well, the accept message includes an indication that type A coding is supported. In this case, the first terminal 11 transmits an SIP/SDP answer message confirming the use of type A coding, and the IP header reduction component 12 sets up a normal transparent header removal or compression.

If the other terminal is the second terminal 20, the accept message includes an indication that type B coding is supported. In this case, the first terminal 10 transmits an SIP/SDP answer message confirming the use of type B coding, and the IP header reduction component 12 sets up a header removal or compression which converts input type A data packets into type B data packets and which converts input type B data packets into type A data packets. This conversion is indicated in FIG. 1 with arrows.

Thus, even if a conversion is required, a transparent end-to-end IP call is maintained, in which each terminal receives data packets, which are encoded with the respectively required type of coding.

It is to be understood that the described approach can be extended to cases in which more than two different types of data packets may be involved. The SIP/SDP invite message transmitted by the first terminal 10 includes then an offer for all involved coding types. If the SIP/SDP accept message indicates another type of data packets than the type used by the first terminal 10, the header removal or compression function provided by the IP header reduction component 12 is modified for a conversion between the respectively accepted pair of types of packets.

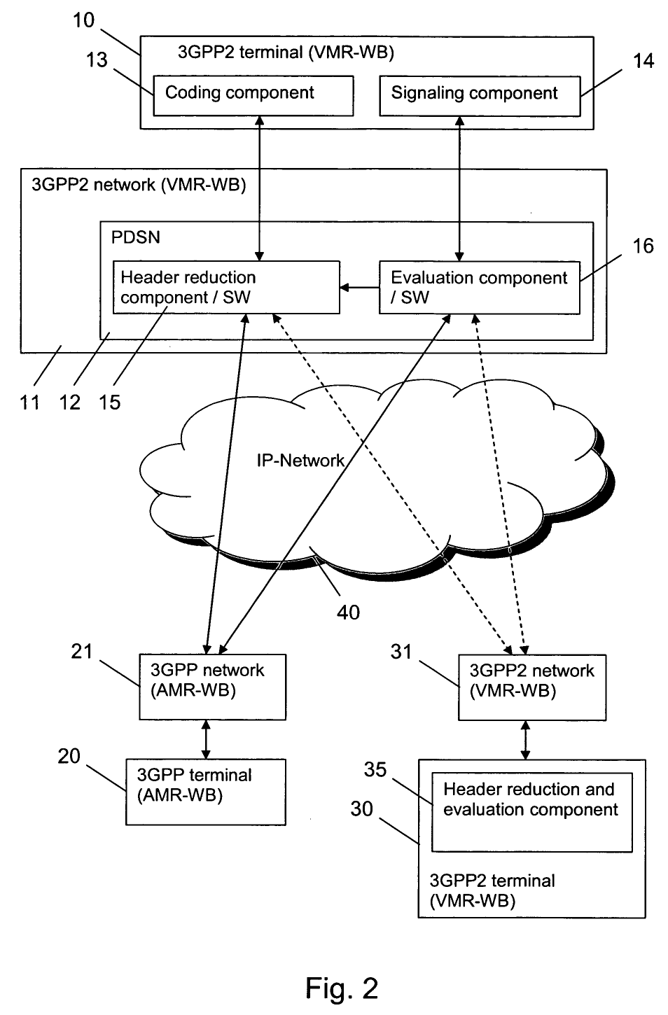

FIG. 2 is a schematic diagram of a system according to an embodiment of the invention, which enables interoperability specifically between 3GPP2 terminals and 3GPP terminals. The same reference signs are used for corresponding components as in FIG. 1.

The system comprises two 3GPP2 terminals 10, 30 supporting VMR-WB. Each terminal 10, 30 accesses a respective 3GPP2 mobile communication network 11, 31. The 3GPP2 mobile communication networks 11, 31 support a transfer of VMR-WB data packets only. Each of the 3GPP2 terminals 10, 30 comprises a coding component 13, namely a VMR-WB codec, and a signaling component 14. The 3GPP2 mobile communication network 11 comprises a network element 12 including a header reduction component 15 and an evaluation component 16. The header reduction component 15 realizes at least one of a service option SO60 for an adjustable header removal and a service option SO61 for adjustable header compression. The header reduction component 15 and the evaluation component 16 may be realized for example in software, which is stored in a memory and run by a processing component of the network element 12.

The protocol stack for service option SO60 and for service option SO61, respectively, is the same as the one presented in the document C.S0047-0, which is referred to for details.

For the service option SO60, a terminal comprises, from bottom to top, a CDMA 2000 MAC (Medium Access Control) layer, an HRL (Header size Reduction component in the lower layer) layer and an HRU (Header size Reduction component in the upper layer) layer including the VMR-WB codec. A network comprises a base station, a PCF (Packet Control Function) and a PDSN (Packet Data Serving Node). The base station comprises, from bottom to top, a CDMA 2000 MAC layer and an HRL layer, and in parallel an IP layer and a GRE (Generic Routing Encapsulation) layer. The HRL layer and the GRE layer are connected to each other via a further layer on top of both. The PCF comprises, from bottom to top, an IP layer and a GRE layer, and in parallel a further IP layer and a further GRE layer. The GRE layers are connected to each other via a further layer on top of both. The PDSN comprises, from bottom to top, an IP layer, a GRE layer, an HRU layer and a further IP layer.

For the service option SO61, a terminal comprises in addition on top of the HRU layer an IP layer.

The network element 12 of FIG. 2 corresponds more specifically to the PDSN, and the header reduction component 15 of FIG. 2 corresponds more specifically to the HRU of the PDSN, which receives data packets via the HRL of a base station of the mobile communication network 11.

The system of FIG. 2 further comprises a 3GPP terminal 20 supporting AMR-WB. The 3GPP terminal 20 accesses a 3GPP mobile communication network 21. The 3GPP mobile communication network 21 supports a transfer of AMR-WB data packets only.

The system further comprises an IP network 40. The mobile communication networks 11, 21, 31 enable a connection between the terminals 10, 20, 30 via the IP network 40.

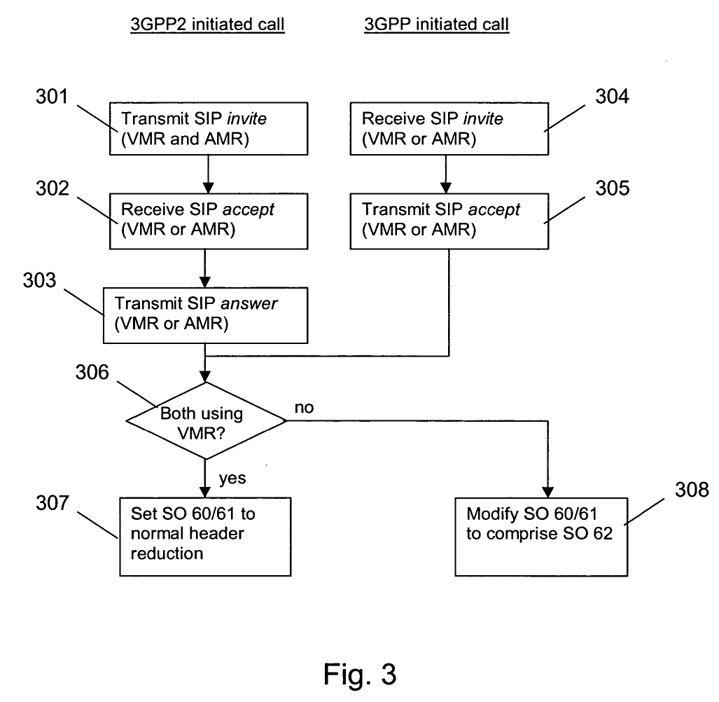

FIGS. 3 to 5 are flow charts illustrating an operation according to an embodiment of the invention in the system of FIG. 2.

When a VoIP connection is to be established between the 3GPP2 terminal 10 and another terminal, it has first to be determined by the terminal 10 which type of coding is supported by the other terminal. This determination is illustrated in FIG. 3.

In case the 3GPP2 terminal initiates the connection, the signaling component 14 of the terminal 10 transmits an SIP/SDP invite message to another terminal 20, 30 (step 301). The invite message offers AMR-WB with VMR-WB mode restrictions, as defined in the above cited document draft-ahmadi-avt-rtp-vmr-wb-02.txt. In addition, it offers VMR-WB.

The VMR-WB mode restrictions implies in particular that only the octet-aligned mode of the AMR-WB RTP payload is allowed. In the octet-aligned mode, all the fields in the payload, including the speech frames, the payload header and table of contents entries, are individually aligned to octet boundaries. The octet-aligned mode is described in the above-cited document RFC 3267, which is referred to for details.

The following example for the SIP/SDP offer for VMR-WB and AMR-WB can be found in the above cited document draft-ahmadi-avt-rtp-vmr-wb-02.txt:

M=audio 49120 RTP/AVP 98 99

A=rtpmap:98 AMR-WB/16000/

A=rtpmap:99 VMR-WB/16000/1

A=ftmp 98 octet-align=1; mode-set=0, 1, 2

Here, “M=” indicates the MIME type “audio”. “A=rtpmap” indicates the encoding names. “1600” indicates the RTP clock rate. “/1” indicates the number of channels, which is one by default. “A=ftmp” indicates any remaining parameters. In the presented offer, it is defined for AMR-WB that the octet-aligned mode has to be selected and that AMR-WB modes 0, 1 and 2 are allowed. These modes use 132, 177 and 253 bits, respectively, for the RTP payload. Another mode for AMR SID (Silence InDication) would use 35 bits.

If the other terminal is the other 3GPP2 terminal 30, the invite message is forwarded via the 3GPP2 mobile communication network 11, the IP network 40 and the further 3GPP2 mobile communication network 31 to the 3GPP2 terminal 30. A signaling component of this terminal 30 responds with a SIP/SDP accept message, which is received by the terminal 10 (step 302). The accept message comprises an indication that the other terminal 30 supports VMR-WB. The signaling component 14 of the terminal then confirms the use of VMR-WB by a SIP/SDP answer message (step 303).

If the other terminal is in contrast the 3GPP terminal 20, the invite message is forwarded via the 3GPP2 mobile communication network 11, the IP network 40 and the 3GPP mobile communication network 21 to the 3GPP terminal 20. A signaling component of this terminal 20 responds with a SIP/SDP accept message, which is received by the terminal 10 (step 302). The accept message comprises an indication that the terminal supports only AMR-WB and accepts the requested mode restrictions. The signaling component 14 of the terminal 10 then confirms the use of AMR-WB with the accepted mode restrictions by a SIP/SDP answer message (step 303).

In case the other 3GPP2 terminal 30 initiates the VoIP connection, the signaling component of this terminal 30 transmits an SIP/SDP invite message to the 3GPP2 terminal 10. The invite message offers AMR-WB with VMR-WB mode restriction. In addition, it offers VMR-WB. The invite message is forwarded via the 3GPP2 mobile communication network 31, the IP network 40 and the 3GPP2 mobile communication network 11 to the 3GPP2 terminal 10. Upon reception of this invite message (step 304), the signaling component 14 of the terminal 10 responds with a SIP/SDP accept message (step 305). The accept message comprises an indication that the terminal 10 supports VMR-WB.

In case the 3GPP terminal 20 initiates the VoIP connection, the terminal 20 transmits an SIP/SDP invite message via the 3GPP mobile communication network 21, the IP network 40 and the 3GPP2 mobile communication network 11 to the 3GPP2 terminal 10 (step 304). The invite message offers only AMR-WB with VMR-WB mode restrictions. The signaling component 14 of the terminal 10 responds with a SIP/SDP accept message (step 305). The accept message comprises an indication that AMR-WB with the accepted VMR-WB mode restrictions can be used.

The network element 12 forwards the SIP/SDP messages between the terminal 10 and the IP network 40. Thus, it has access to the SIP answer message or the SIP accept message, respectively, which is transmitted by the terminal 10 in step 303 or step 305, respectively.

The evaluation component 16 of the network element 12 evaluates the SIP answer message or the SIP accept message, respectively (step 306).

If the evaluated message indicates that the other terminal 30 supports VMR-WB, the evaluation component 16 causes the header reduction component 15 to perform a normal header reduction (step 307). More specifically, it sets the service option SO60 to perform a normal header adding or the service option SO61 to perform normal header decompression on incoming VMR encoded data packets provided by the terminal 10. The headers of the data packets provided by the terminal 10 are thus expanded and the resulting data packets are forwarded to the IP network 40. The 3GPP2 mobile communication network 31 may then optionally apply a header reduction before forwarding the data packets to the other terminal 30. Further, the evaluation component 16 sets the service option SO60 to perform a normal header removal or the service option SO61 to perform normal header compression on incoming VMR encoded data packets provided by the IP network 40. The headers of the data packets provided by the IP network 40 are thus reduced and the resulting data packets are forwarded to the terminal 10.

On the other hand, if the evaluated message indicates that the other terminal 20 supports only AMR-WB, the evaluation component 16 causes the header reduction component 15 to invoke a modified service option SO60 or 61, including interoperability service option SO62 defined in the above-cited document C.S0052-0.

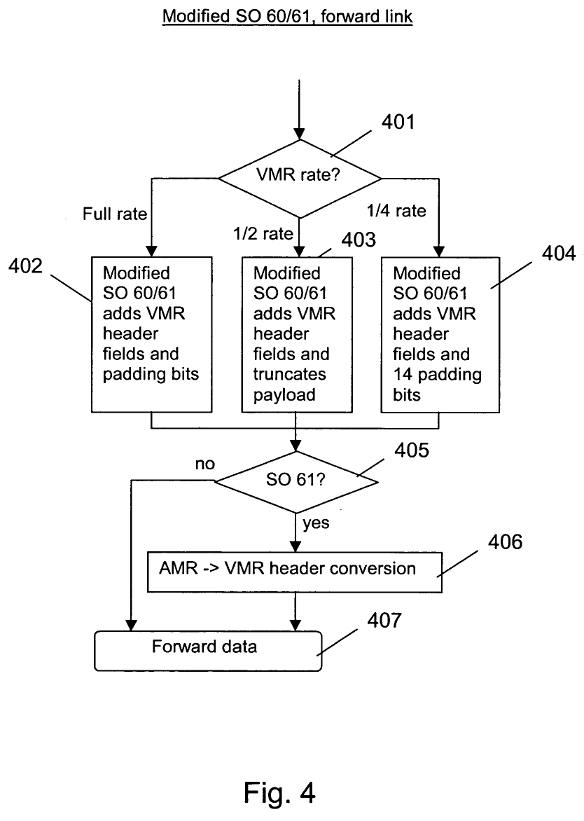

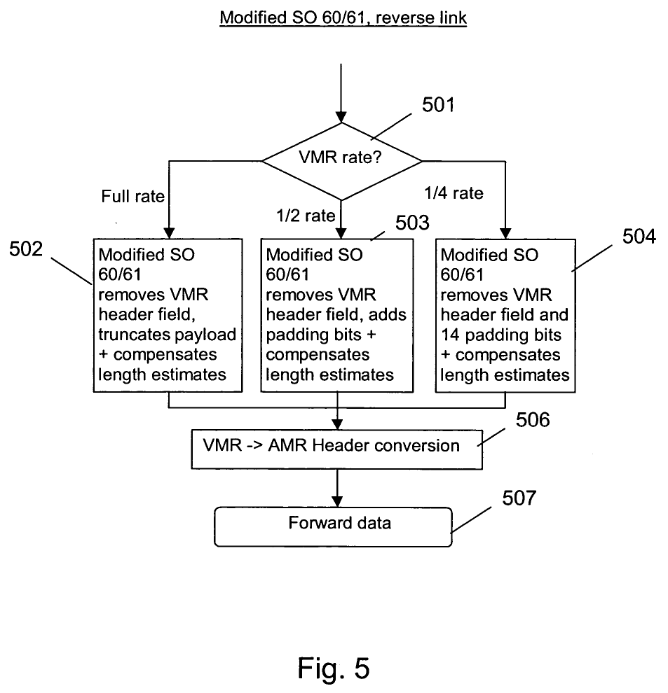

The modified service options SO60 and SO61 are described in the following with reference to FIGS. 4 and 5.

Modified service options SO60 and SO61 for the forward link, that is, for data packet transmissions from one of the other terminals 20, 30 to the terminal 10, are illustrated in FIG. 4.

In the case of a forward link transmission, the header reduction component 15 examines first the incoming AMR data packets. These packets have an RTP payload length of 253, 177, 132 or, for AMR SID, 35 bits. An AMR SID frame is implicitly part of the interoperable mode. Therefore, it has to be converted, even if not included as an allowed AMR-WB mode in the above MIME description. The header reduction component 15 then generates a full-rate, a half-rate or a quarter-rate VMR-WB frame for delivery to the HRL of the base station and further to the terminal 10. Moreover, the header reduction component 15 determines whether a full-rate VMR-WB frame, a half-rate VMR-WB frame or a quarter-rate VMR-WB frame is to be delivered (step 401).

If a full-rate VMR-WB frame comprising 266 bits is to be delivered, the header reduction component 15 adds a corresponding VMR-WB header field to the RTP payload. This is described in detail in the above-cited document C.S0052-0, which is referred to for details. The header reduction component 15 moreover adds 0, 76, or 121 bits padding, respectively, depending on the employed AMR mode 2, 1, or 0. (step 402)

If a half-rate VMR-WB frame comprising 124 bits is to be delivered, the header reduction component 15 equally adds a corresponding VMR-WB header field. In addition, the header reduction component 15 truncates the AMR mode 2, 1 or 0 RTP payloads by 144, 66, or 21 bits, respectively. (step 403)

If a quarter-rate VMR-WB frame comprising 54 bits is to be delivered due to an AMR SID payload, the header reduction component 15 equally adds a corresponding VMR header field to the AMR SID bits, and moreover 14 padding bits (step 404).

In the case of service option SO61 (step 405), the header reduction component 15 moreover converts any AMR-WB specific fields in the RTP/UDP/IP headers included in the RTP payload to VMR-WB specific fields in RTP/UDP/IP headers included in the RTP payload (step 406).

The decompression of the header of the generated VMR-WB frame on the side of the terminal 10 requires no modification in HRU or HRL.

Modified service options SO60 and SO61 for the reverse link, that is for data packet transmissions from the terminal 10 to one of the other terminals 20, 30, are illustrated in FIG. 5.

In the case of a reverse link transmission, the header reduction component 15 examines first the VMR-WB header field of the VMR-WB frame received from the HLR of a base station of the mobile communication network 11. The header reduction component 15 determines in particular whether a full-rate frame, a half-rate frame or a quarter-rate frame is received (step 501).

If a full-rate frame comprising 266 bits is received, the header reduction component 15 generates a 253, 177 or 132 bit AMR-WB RTP packet (step 502). To this end, it removes the VMR-WB header field of the received VMR-WB frame. This is described in detail in the above-cited document C.S0052-0, which is referred to for details. Further, the header reduction component 15 truncates the RTP payload of the received VMR-WB frame by 0, 76 or 121 bits, respectively, and compensates the payload length estimates by the number of truncated bits.

If a half-rate frame comprising 124 bits is received, the header reduction component 15 generates a 253, 177 or 132 bit AMR-WB RTP packet (step 503). To this end, it removes the VMR-WB header field of the received VMR-WB frame. Further, it appends 144, 66 or 21 padding bits, respectively, and compensates the payload length estimates by the net number of appended bits.

If a quarter-rate frame comprising 54 bits is received, the header reduction component 15 generates a 35 bit AMR-WB SID RTP packet (step 504). To this end, it removes the VMR-WB header field and the last 14 padding bits of the received VMR-WB frame. Moreover, the header reduction component 15 compensates the payload length estimate by the net number of truncated bits.

In addition, the header reduction component 15 replaces any VMR-WB specific fields in the RTP/UDP/IP headers included in the RTP payload of the received VMR-WB frame by AMR-WB specific fields in headers included in the RTP payload.

The compression of the header for the provided VMR-WB frame on the side of the terminal 10 requires no modification in HRU or HRL.

On the whole, it becomes apparent that an advantageous combination of header reduction based on 3GPP2 service option SO60 or SO61 and interoperability conversion based on 3GPP2 service option SO62 is achieved.

In the described embodiments of the invention, the modifications are carried out exclusively on the network side, since here, most computational resources are available. It is to be understood, though, that the modifications may also be distributed between the network and the terminal or reside completely at the terminal side.

In FIG. 2, for example, the 3GPP2 mobile communication networks 31 might comprise only a header reduction component (not shown), which realizes a service option SO60 for a conventional header removal of VMR-WB data packets and/or the service option SO61 for a conventional header compression of VMR-WB data packets. In the 3GPP2 terminal 30, however, the HRU layer has been modified. The HRU corresponds to a depicted header reduction and evaluation component 35, which is able to decompress a compressed header of received VMR-WB data packets and to compress the header of a VMR-WB data packet generated for transmission. Whenever a data exchange with another terminal 20 is to be enabled which supports only AMR-WB, the header reduction function realized by the header reduction and evaluation component 35 is modified to carry out a conversion between AMR-WB data packets and VMR-WB data packets. The decision on the modification is carried out by the evaluation part of the header reduction and evaluation component 35, which evaluates signaling messages, which are exchanged between the terminal 30 and another terminal for determining the type of coding supported by this other terminal.

For a distributed modification, the evaluation which type of coding is supported by the other terminal may be implemented for instance at another location than the conversion.

Similarly as the header reduction proposed for the embodiment described with reference to FIGS. 3 to 5, also the ROHC header compression for GSM and WCDMA systems can be modified to convert VMR-WB packets to AMR-WB, and vice versa. To this end, an equivalent SIP/SDP signaling can be employed to indicate VMR-WB and AMR-WB interoperability scenarios, and equivalent modifications in the ROHC compression/decompression can be enabled.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps, which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for enabling an exchange of encoded data packets between a first electronic device and a second electronic device, wherein said first electronic device supports a first type of coding, said method comprising:
in case said second electronic device supports said first type of coding, using a header reduction component to perform a header reduction and extension, respectively, on data packets encoded with said first type of coding, which are exchanged between said first electronic device and said second electronic device; and
in case said second electronic device supports a second type of coding, modifying said header reduction component to convert data packets encoded with said second type of coding, originating from said second electronic device and addressed to said first electronic device into data packets encoded with said first type of coding, and to convert data packets encoded with said first type of coding, originating from said first electronic device and addressed to said second electronic device into data packets encoded with said second type of coding.

2. The method according to claim 1, wherein said header reduction comprises one of a header removal and a header compression and wherein said header extension comprises one of a header adding and a header decompression.

3. The method according to claim 1,
wherein said header reduction component is a part of said first electronic device;
wherein said header reduction comprises a header reduction of data packets which are encoded with said first type of coding by said first electronic device and which are addressed to said second electronic device; and
wherein said header extension comprises a header extension of data packets which are encoded with said first type of coding, which originate from said second electronic device and which are received by said first electronic device.

4. The method according to claim 1,
wherein said first electronic device accesses a network via which said encoded data packets are exchanged;
wherein said header reduction component is a part of said network;
wherein said header reduction comprises a header reduction of data packets which are encoded with said first type of coding, which originate from said second electronic device and which are addressed to said first electronic device; and
wherein said header extension comprises a header extension of data packets which are encoded with said first type of coding, which originate from said first electronic device and which are addressed to said second electronic device.

5. The method according to claim 1, wherein said data packets comprise speech data, wherein said first type of coding is a Variable-Rate Multi-Mode Wideband VMR-WB speech coding and wherein said second type of coding is an Adaptive Multi-Rate Wideband AMR-WB speech coding.

6. The method according to claim 5, wherein a conversion of an AMR-WB encoded data packet to a VMR-WB encoded data packet comprises,
if a full rate VMR-WB frame is to be used as said VMR-WB encoded data packet, adding a corresponding VMR-WB header field to said AMR-WB encoded data packet, and adding padding bits to said AMR encoded data packet as far as required depending on the length of said AMR-WB encoded data packet;
if a half rate VMR-WB frame is to be used as said VMR-WB encoded data packet, adding a corresponding VMR-WB header field to said AMR-WB encoded data packet and truncating said AMR-WB encoded data packet as far as required depending on the length of said AMR-WB encoded data packet; and
if a quarter rate VMR-WB frame is to be used as said VMR-WB encoded data packet, adding a corresponding VMR-WB header field and padding bits to said AMR-WB encoded data packet.

7. The method according to claim 6, wherein in case said header reduction is a header compression, said conversion further comprises converting AMR-WB specific fields in headers in a payload of said encoded data packet to VMR-WB specific fields in headers in said payload of said encoded data packet.

8. The method according to claim 5, wherein a conversion of a VMR-WB encoded data packet to an AMR-WB encoded data packet comprises,
if said VMR-WB encoded data packet is a full rate VMR-WB frame, removing a VMR-WB header field from said VMR-WB encoded data packet, truncating a payload of said VMR-WB encoded data packet as far as required for the length of said to be generated AMR-WB encoded data packet, and compensating payload length estimates by the number of truncated bits;
if said VMR-WB encoded data packet is a half rate VMR-WB frame, removing a VMR-WB header field from said VMR-WB encoded data packet, appending padding bits to a payload of said VMR-WB encoded data packet as far as required for the length of said to be generated AMR data packet, and compensating payload length estimates by the net number of appended bits; and
if said VMR-WB encoded data packet is a quarter rate VMR-WB frame, removing a VMR-WB header field from said VMR data packet, removing the last 14 padding bits from a payload of said VMR-WB encoded data packet, and compensating payload length estimates by the number of truncated bits.

9. The method according to claim 8, further comprising converting VMR-WB specific fields in headers in a payload of said encoded data packet to AMR-WB specific fields in a payload of said encoded data packet.

10. The method according to claim 1, wherein said header reduction and said header extension performed by said header reduction component is based on one of 3rd Generation Partnership Project 2 3GPP2 service option SO60 and 3GPP2 service option SO61, and wherein said conversion performed by said modified header reduction component is based on a 3GPP2 service option SO62.

11. The method according to claim 1, wherein said header reduction and said header extension performed by said header reduction component is a Robust Header Compression ROHC defined for a Global System for Mobile communications and for a Wideband Code Division Multiple Access system.

12. The method according to claim 1, wherein said header reduction component comprises a header reduction algorithm adapted to realize said header reduction, said header extension and said conversion.

13. The method according to claim 1, wherein said first electronic device and said second electronic device exchange at least one signaling message indicating a type of coding supported by said second electronic device.

14. The method according to claim 13, wherein said indication is evaluated at at least one of said first electronic device and a network element of a network which is accessed by said first electronic device for determining which type of coding is supported by said second electronic device.

15. The method according to claim 13, wherein said first electronic device transmits an invite message to said second electronic device inviting said second electronic device to participate in a data exchange using either said first type of coding or said second type of coding, and wherein said first electronic device receives an accept message from said second electronic device accepting said invitation, said accept message comprising an indication of a coding type supported by said second electronic device.

16. The method according to claim 13, wherein said first electronic device receives an invite message from said second electronic device inviting said first electronic device to participate in a data exchange, said invite message indicating a type of coding supported by said second electronic device.

17. The method according to claim 1, wherein at least one of a Session Initiation Protocol SIP signaling and a Session Description Protocol SDP signaling is employed for determining a type of coding supported by said second electronic device.

18. A header reduction component enabling an exchange of encoded data packets between a first electronic device and a second electronic device, wherein said first electronic device supports a first type of coding;
wherein said header reduction component is adapted to perform a header reduction and extension, respectively, on data packets encoded with said first type of coding, which are exchanged between said first electronic device and said second electronic device, in case said second electronic device supports said first type of coding; and
wherein said header reduction component is adapted to convert data packets encoded with said second type of coding, originating from said second electronic device and addressed to said first electronic device into data packets encoded with said first type of coding, and to convert data packets encoded with said first type of coding, originating from said first electronic device and addressed to said second electronic device into data packets encoded with said second type of coding, in case said second electronic device supports a second type of coding.

19. The header reduction component according to claim 18, further comprising an evaluation component adapted to evaluate signaling messages which are exchanged between said first electronic device and said second electronic device for determining the type of coding supported by said second electronic device.

20. An electronic device comprising a header reduction component enabling an exchange of encoded data packets between said electronic device and another electronic device and a codec supporting a first type of coding;
wherein said header reduction component is adapted to perform a header reduction and extension, respectively, on data packets encoded with said first type of coding, which are exchanged between said electronic device and said other electronic device, in case said other electronic device supports said first type of coding; and
wherein said header reduction component is adapted to convert data packets encoded with said second type of coding, originating from said other electronic device and addressed to said electronic device into data packets encoded with said first type of coding, and to convert data packets encoded with said first type of coding, originating from said electronic device and addressed to said other electronic device into data packets encoded with said second type of coding, in case said other electronic device supports a second type of coding.

21. A network element for a communication network, which network element comprises a header reduction component enabling an exchange of encoded data packets between a first electronic device and a second electronic device, wherein said first electronic device supports a first type of coding,
wherein said header reduction component is adapted to perform a header reduction and extension, respectively, on data packets encoded with said first type of coding, which are exchanged between said first electronic device and said second electronic device, in case said second electronic device supports said first type of coding; and
wherein said header reduction component is adapted to convert data packets encoded with said second type of coding, originating from said second electronic device and addressed to said first electronic device into data packets encoded with said first type of coding, and to convert data packets encoded with said first type of coding, originating from said first electronic device and addressed to said second electronic device into data packets encoded with said second type of coding, in case said second electronic device supports a second type of coding.

22. A communication system enabling an exchange of encoded data packets between a first electronic device and a second electronic device, said communication system comprising a communication network, said first electronic device and a header reduction component,
wherein said first electronic device supports a first type of coding and is adapted to access said communication network;
wherein said header reduction component is adapted to perform a header reduction and extension, respectively, on data packets encoded with said first type of coding, which are exchanged between said first electronic device and said second electronic device, in case said second electronic device supports said first type of coding; and
wherein said header reduction component is adapted to convert data packets encoded with said second type of coding, originating from said second electronic device and addressed to said first electronic device into data packets encoded with said first type of coding, and to convert data packets encoded with said first type of coding, originating from said first electronic device and addressed to said second electronic device into data packets encoded with said second type of coding, in case said second electronic device supports a second type of coding.

23. The communication system according to claim 22, further comprising an evaluation component adapted to evaluate signaling messages which are exchanged between said first electronic device and said second electronic device for determining the type of coding supported by said second electronic device and adapted to modify said header reduction component accordingly.

24. A software program product in which a software code for enabling an exchange of encoded data packets between a first electronic device and a second electronic device is stored, wherein said first electronic device supports a first type of coding, said software code realizing the following steps when running in a processing component:
in case said second electronic device supports said first type of coding, performing a header reduction and extension, respectively, on data packets encoded with said first type of coding, which are exchanged between said first electronic device and said second electronic device; and
in case said second electronic device supports a second type of coding, converting data packets encoded with said second type of coding, originating from said second electronic device and addressed to said first electronic device into data packets encoded with said first type of coding, and converting data packets encoded with said first type of coding, originating from said first electronic device and addressed to said second electronic device into data packets encoded with said second type of coding.
